(19) United States
(12) Patent Application Publication
(10) Pub. No.: US 2003/0133303 A1
(43) Pub. Date: Jul. 17, 2003

(54) Anchor structure for lampstand

(76) Inventor: Chung-Kai Chen, Heng Li Town (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 10/190,845

(22) Filed: Jul. 9, 2002

(30) Foreign Application Priority Data
Jan. 11, 2002 (CN) 02225059.X

(51) Int. Cl. F21S 8/08

(52) U.S. Cl. 362/410; 362/414; 362/401

(57) ABSTRACT

An anchor structure for a lampstand includes a wedging slot and an elastic base plate located below the wedging slot in parallel with the wedging slot. The wedging slot has an opening for clamping a board at a desired location where the lampstand is to be mounted. The wedging slot may be pushed to fully clamp the board to form a secured anchoring for the lampstand. The invention has a simple structure and can greatly reduce the production cost.

### BACKGROUND OF THE INVENTION

1. Field of the Invention

The present invention relates to an anchor structure for a lampstand and particularly a structure for mounting the lampstand rapidly on a desired location that has a simple structure to reduce production cost.

2. Description of the Prior Art

Lighting apparatus (lamps) are widely used in households. They are formed in various shapes to serve different purposes, and are being mounted onto lampstands and being anchored on selected locations to meet users different requirements. In general, the anchor structures for the lampstands can be grouped as follows:

1. Attach a counter weight on the lampstand to lower the gravity center, and employ a balanced force to anchor the lampstand.

2. Make the lampstand to become a spring clip to clamp a platform for anchoring.

The lampstands set forth above have drawbacks. For instance, the lampstand with a counter weight becomes heavy and cumbersome, and is difficult to carry and move. The lampstand consisting of a spring clip is lighter, however the elastic force gradually decreases after using for a long time period. As a result, anchoring effect is reduced. Moreover, its structure is complex and the production cost is higher and is more expensive. There are stillrooms for improvement.

### SUMMARY OF THE INVENTION

In view of aforesaid disadvantages, the primary object of the invention is to provide an improved lampstand that can be mounted securely and conveniently, and has a simple anchoring structure to reduce the production cost.

The lampstand according to the invention has a wedging slot and a base plate located below the wedging slot in parallel with the wedging slot. The wedging slot has an opening for clamping a board at a desired location. The wedging slot may be pushed to fully clamp the board to form a secured anchoring for the lampstand.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the present invention;

FIG. 2 is a side view of the present invention.

### DETAILED DESCRIPTION OF THE PREFERRED EMBODIMENT

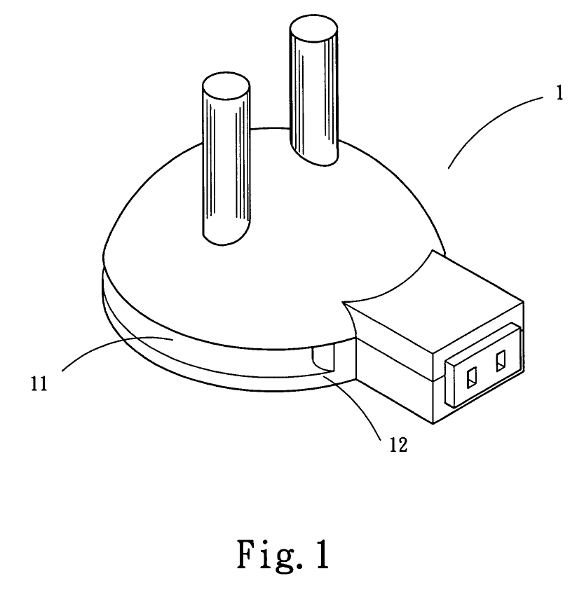

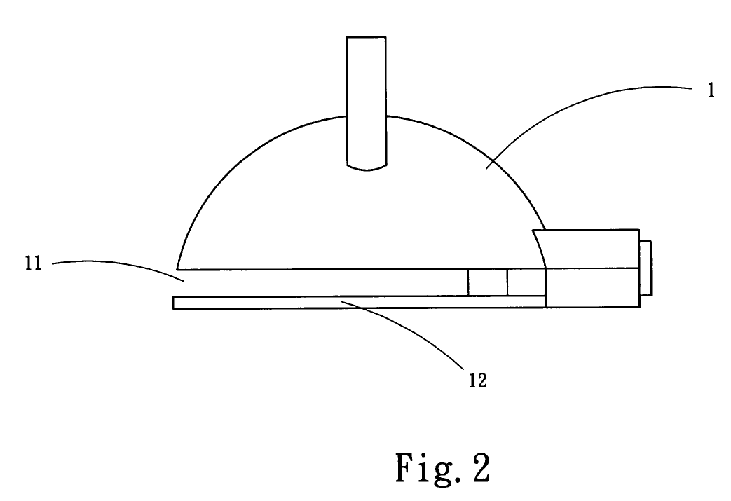

Referring to FIGS. 1 and 2, the lampstand 1 according to the invention mainly includes a wedging slot 11 and a base plate 12 located below the wedging slot 11 in parallel with the wedging slot. The base plate 11 is an elastic plate.

The wedging slot 11 has an opening, which may clip a board at a location where the lampstand is to be mounted. The wedging lot 11 may be pushed to fully clamp the board between the lampstand and the base plate 12 to form a secured anchoring.

Because the base plate 12 is elastic, the wedging slot 11 may be clamped on the board easily and securely to anchor the lampstand on a desired location. In addition, the structure is simple, and can greatly reduce the production cost.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What is claimed is:

1. An anchor structure for a lampstand comprising a wedging slot in the lampstand for anchoring the lampstand on a desired location.

2. The anchor structure for a lampstand of claim 1 further having a base plate located below the wedging slot, the base plate being parallel with the wedging slot.

3. The anchor structure for a lampstand of claim 2, wherein the base plate is an elastic plate.
